(19) United States
(12) Patent Application Publication
(10) Pub. No.: US 2010/0332485 A1
(43) Pub. Date: Dec. 30, 2010

(54) ORDERING OF DATA ITEMS

(75) Inventors: Pasi Pekka Lahti, Helsinki (FI); Marko Juha Sakari Lindgren, Espoo (FI); Aki Juhani Tamminen, Tampere (FI); Eeve Pilke, Helsinki (FI); Ilmo Kalevi Ikonen, Tuusula (FI); Eino Lipiäinen, Espoo (FI); Jouni Tapani Rapakko, Kylmakoski (FI); Jari Laurila, Kirkkonummi (FI); Petri Lipponen, Kerava (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/745,690

(22) PCT Filed: Nov. 26, 2008
(86) PCT No.: PCT/IB08/03242

§ 371 Date: Sep. 14, 2010

Related U.S. Application Data
(60) Provisional application No. 60/991,366, filed on Nov. 30, 2007.

(51) Int. Cl. G06F 17/30

(52) U.S. Cl. 707/758; 707/E17.009

(57) ABSTRACT

Different types of data are provided in a device, and data features are automatically extracted from the data for comparison and presentation on a display of the device where a multidimensional spatial relationship between the data on the display depends on a strength of similarities between the data features.

### BACKGROUND

1. Field

The disclosed embodiments generally relate to user interfaces and, more particularly, to classifying and presenting multimedia data.

2. Brief Description of Related Developments

Management of different media types in a device can be done in various ways such as by file extensions or types and dates. Adding metadata to the media files improves the ability to search and find files, but generally metadata relies on textual information added to the media file. Adding very descriptive metadata is a time consuming and tedious task that is more often than not postponed by a user of the device leaving a search function of the device to operate with automatically added metadata (e.g. dates, file size and file type). Metadata searches generally work best for searching one media type at a time and do not provide for linking and associating different types of media items.

It would be advantageous to be able to establish links and associations between different types of items and present those different types of items based on the established links and associations.

### SUMMARY

In one aspect, the disclosed embodiments are directed to a method. In one embodiment the method includes providing different types of data in a device, automatically extracting data features from the data for comparison and automatically presenting the data on a display of the device where a multidimensional spatial relationship between the data on the display depends on a strength of similarities between the data features.

In another aspect, the disclosed embodiments are directed to an apparatus. In one embodiment the apparatus includes a processor and a display connected to the processor wherein the processor is configured to access different types of data associated with the apparatus, extract data features from the data for comparison and present the data on the display where a multidimensional spatial relationship between the data on the display depends on a strength of similarities between the data features.

In another aspect, the disclosed embodiments are directed to a user interface. The user interface includes an input device, a display and a processor connected to the input device and display, the processor being configured to access different types of data associated with the apparatus, extract data features from the data for comparison and present the data on the display where a multidimensional spatial relationship between the data on the display depends on a strength of similarities between the data features.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates a flow diagram in accordance with the disclosed embodiments;

FIG. 3 illustrates another flow diagram in accordance with an aspect of the disclosed embodiments;

FIGS. 4-7 are illustrations of exemplary screen shots of a user interface in accordance with the disclosed embodiments;

FIGS. 8A and 8B are illustrations of examples of devices that can be used to practice aspects of the disclosed embodiments;

FIG. 9 illustrates a block diagram of an exemplary system incorporating features that may be used to practice aspects of the disclosed embodiments; and

FIG. 10 is a block diagram illustrating the general architecture of an exemplary system in which the exemplary devices of FIGS. 8A and 8B may be used.

### DETAILED DESCRIPTION OF THE EMBODIMENT(S)

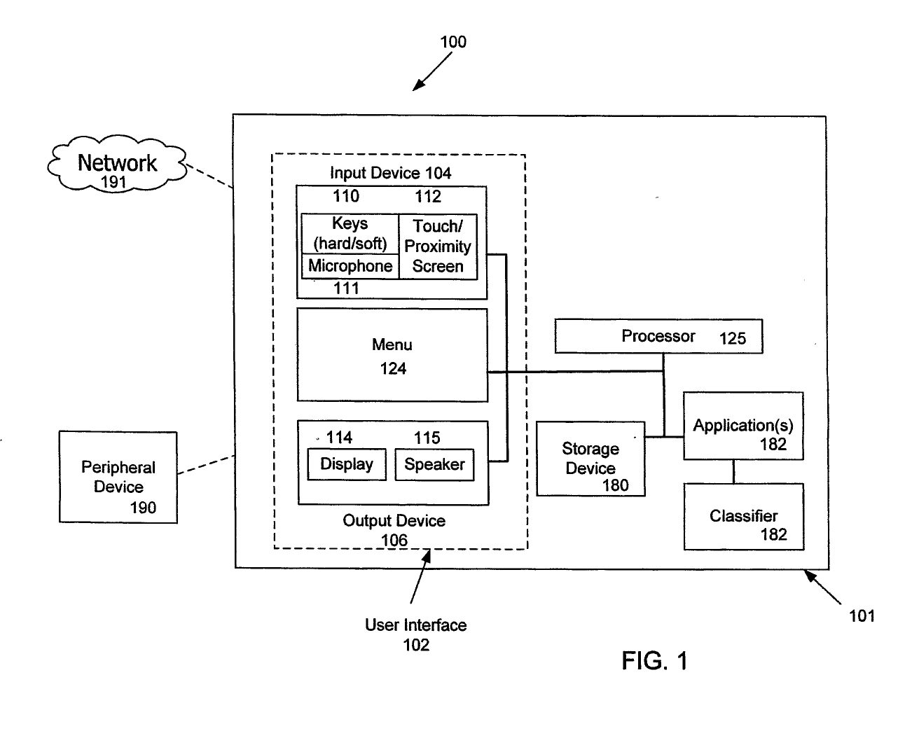

FIG. 1 illustrates one embodiment of a system 100 in which aspects of the disclosed embodiments can be used. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments generally allow a user of a device 101 to re-live and explore connections and links between different items or data accessible by or stored in the device 101 where the connections and links may or may not be known to the user. The data can be any suitable data including, but not limited to, bookmarks, global positioning information, playlists, instant messaging presence, programs, shortcuts, help features, images, videos, audio, text, message files or any other items that originate from the device's operating system and/or applications or from a remote location. Generally the disclosed embodiments classify the data based on a number of different criteria including, but not limited to, metadata and other qualities of the data (e.g. all available information pertaining to each file or item can be extracted and used) as will be described in greater detail below.

The characterized data are grouped together or sorted and presented to a user of the device 101 through a display 114 of the device 101. The sorted data are presented on the display 114 in the form of a map, grid or other visual representation of the files where the data include one or more types of data as described above. The manner in which the data are grouped may be unexpected to the user so that browsing or exploring the items is fun to the user. It is also noted that relationships are built between the data so that, for example, photos taken and songs listened to during an event will be presented to the user as a group.

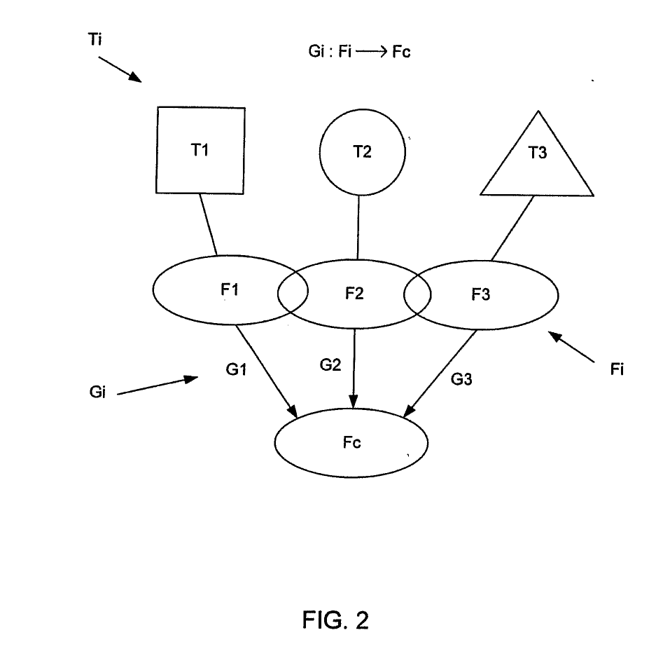

Referring also to FIG. 2, in the disclosed embodiments an input Ti, is a collection of media file types T1-T3 that is gathered from the device 101 or from a remote location. It is noted that the exemplary embodiments will be described herein with respect to media files but, as described above, in other embodiments any suitable data from the device or accessible to the device can be used. Each of the media file types T1-T3 include a set of media type specific features F1-F3 (collectively referred to as Fi). These media type specific features F1-F3 can be extracted from, for example, the media corresponding to the media file types T1-T3 and/or from metadata associated with the media files. Any suitable mapping function(s) G1-G3 (collectively referred to as Gi) is defined for each media type so that a common set of media features Fc is formed from the media specific features Fi. In forming the common set of media features Fc, the device 101 determines connections or links between the different input T1-T3 based on the media type specific features F1-F3. The media type specific features may be any suitable features associated with the media. Some non-limiting examples of the media type specific features F1-F3 which may or may not be included in metadata but can be inferred from the input T1-T3 include, but are not limited to, a frequency of usage of the media file, media type creation date, media recording location (such as for music and images), user created tags, metadata available from music tracks and provided by recording devices (e.g. cameras, digital voice recorders, etc.), global positioning information attached to the media file, keywords, a tempo of music, genre of music or video, genre colors, average color of an image or video frame, color distribution of an image or video frame, color layout descriptors, average brightness of an image or video frame, textures in an image or video, length of words in text, number of words in text, text content, file name and file size. At least these exemplary features can be compared to each other and/or matched in any suitable combination(s) to establish relationships between one or more media items.

Each of the features F in the common features Fc is considered as a vector such that, for example, two or more feature vectors that belong to a set of common features Fc (equation [1])

\vec{F}₁,\vec{F}₂εF_{c} [1]

can be weighted with a weight vector (equation [2]) which allows a user to influence how the media files of the media file types T1-T3 are grouped and presented to the user.

\vec{w} [2]

These feature vectors can be compared for similarity using any suitable distance metrics d such that

d:F_{c}×F_{c}→ [symbol] [3]

where d is the distance and R is the vector space (which can have any suitable number of dimensions to account for the different features of the media items). The disclosed embodiments will be described with reference to Euclidean distance metrics that can be defined as

d_{E}(x,y)\sqrt{(ε₁−η₁)²+(ε₂−η₂)²+ . . . +(εₙ−ηₙ)²} [4]

where εₙ and ηₙ are points in the vector space. It is noted that in other examples other metrics including, but not limited to, direction cosines, Minkowski metric, Tanimoto similarity and Hamming distance can be used.

The methods for measuring the distances between the features F (i.e. the feature vectors) of the media file types T1-T3 are used to classify and visualize the media file types T1-T3 and their features F1-F3. For example, the classification of the media item features F belonging to the common set of features Fc can be mapped to a discrete set of classes using a classifier algorithm M_{c} as shown in equation [5].

M_{c}:F→C [5]

Where C is a set of classes (e.g. class space) used in the classification and the features F can be weighted by the weighting vector. The classifier algorithm M_{c} can be any suitable classifier algorithm including, but not limited to neural networks, learning vector quantization, thresholding and different statistical methods.

The visualization of the media item features F belonging to the common set of features Fc can be mapped to a discrete set of classes using a mapping function, such as visualizer/mapping function Mᵥ as shown in equation [6].

Mᵥ:F→ [symbol] ⁿ [6]

Where Rⁿ is a vector space having n dimensions and the features F can be weighted by the weighting vector. The visualizer/mapping function Mᵥ can be any suitable visualizer/mapping function.

The connections and links formed between media files of the media file types T1-T3 through mapping the features to the discrete classes as described above with respect to equations [3]-[6] are used to visually present the media files on the display 114 in dependence on those connections and links as will be described in greater detail below. The media files of the media file types T1-T3 can be presented in any suitable number of dimensions on the display 114 such as, for example, in a two dimensional view or a three dimensional view. The relationships between the media files can be represented on the display 114 as a distance between the media items. For example, items that are connected or related to each other through one or more of the media item features Fi are located close to each other and/or placed in groupings on the display while items that are not connected to each other are spaced apart. In another example, media items that share features may appear larger in size than items that do not share features. In still other examples, the items can be arranged on the display in any suitable manner to indicate to the user that the items are related or not related.

It is noted that the above equations for grouping the items and their respective features are provided for exemplary purposes only and that any suitable equations, methods and functions can be used to group and present the items in the manner described below.

In one embodiment, still referring to FIG. 1, the device 101 can include an input device 104, output device 106, a processor 125, applications area 182, and storage device 180. In one embodiment the storage 180 is configured to store the media items that are presented on the display 114 while in other embodiments the device 101 is configured to obtain one or more of the media items from a network 191 or a peripheral device 190. The network may be any suitable wired or wireless network including the Internet and local or wide area networks. The peripheral device 190 can be any suitable device that can be coupled to the device 101 through any suitable wired or wireless connections (e.g. cellular, Bluetooth, Internet connection, infrared, etc.). In one embodiment the applications area 180 includes a classifier module 182 configured to classify media item features as described herein. In another embodiment the processor 125 may be configured to implement the classifier module 182 and perform functions for carrying out the disclosed embodiments. In other embodiments the processor 125 and the classifier module 182 can be an integrated unit. It is further noted that the components described herein are merely exemplary and are not intended to encompass all components that can be included in the device 101. For example, in one embodiment the applications of the device 101 may include, but are not limited to, data acquisition (e.g. image, video and sound), and multimedia players (e.g. video and music players). Thus, in alternate embodiments, the device 101 can include other suitable modules and applications for monitoring application content and acquiring data and providing communication capabilities in such a device. While the input device 104 and output device 106 are shown as separate devices, in one embodiment, the input device 104 and output device 106 can be combined and be part of, and form, the user interface 102.

In one embodiment, the user interface 102 of the disclosed embodiments can be implemented on or in a device that includes a touch screen display or a proximity screen device 112. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not necessarily require direct contact, but can include near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where navigation on the display is performed through, for example, keys 110 of the device 101 or through voice commands via voice recognition features of the device 101.

In one embodiment, the user interface 102 includes a menu system 124. The menu system 124 can provide for the selection of different tools, settings and application options related to the applications or programs running on the device 101. In one embodiment, the menu system 124 may provide for the selection of applications or features associated with the presentation of media items such as, for example, any suitable setting features including, but not limited to, the settable features described herein. In one embodiment, the menu system 124 provides a way for the user of the device 101 to configure how the media file features Fi are grouped and compared against one another. The media file features Fi or grouping parameters can be set in any suitable manner. In one embodiment the menu system 124 can provide a way for the user to adjust any suitable number of parameters for grouping the media items. The menu system 124 can include any suitable text or graphics based menu or features that can be manipulated by the keys 110, touch screen 112 and/or microphone (e.g. through voice commands) of the input device 104. In another embodiment the menu system 124 can be configured to allow a user to configure the device 101 so that the grouping and visualization of the media items can be performed with great specificity. For example, the user can, through the menu system 124, specify any or all of the parameters or media item features that are used when grouping the media items.

The user may also be able to assign a weighting factor to groups of media item features and/or to each individual media item feature through the menu system 124. Assigning a weight to one or more media item features allows, for example, media item features with a heavier weight to influence the grouping of the media item more than media item features with a lesser weight. In one embodiment, it is noted that entering specific parameters for each individual media item feature will aid the user in quickly finding a media item. In other embodiments, one or more of the media item features can be hidden from the user so that the user has a generalized control over which parameters are used in grouping the media items. In another embodiment, the grouping parameters can be separated into different categories where the weighting within the different categories can be manipulated to provide some control over how the media items are grouped together. In still other embodiments the device 101 can be configured so that the grouping parameters are set by the device 101. For example, the grouping parameters can be set during manufacturing of the device, sets of parameters can be downloaded and/or installed into the device or the device can randomly select the grouping parameters. Having limited control over the grouping parameters could provide a source of entertainment to a user and group the media items in unexpected and surprising ways that the user may not think of. It is noted that the embodiments described herein will be described with respect to graphics based control over the grouping parameters for exemplary purposes only.

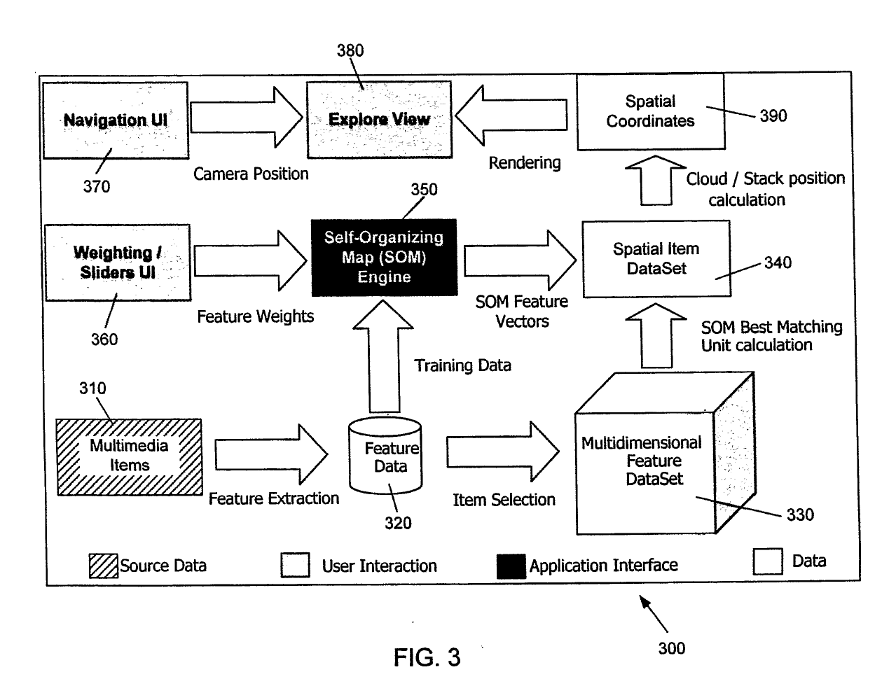

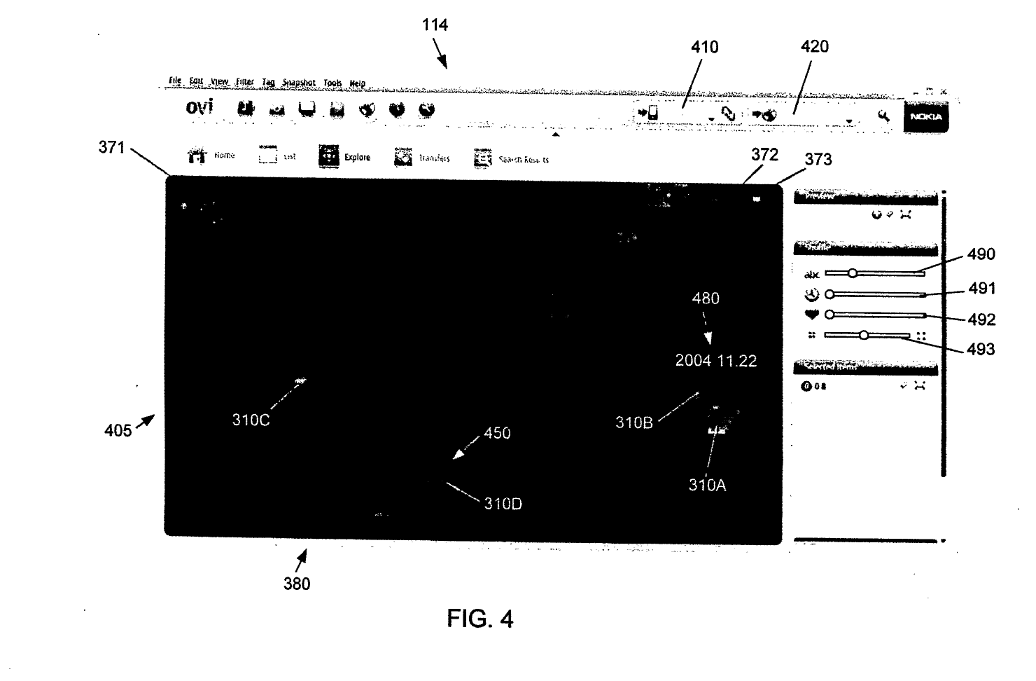

Referring now to FIGS. 3 and 4 an exemplary architecture and data flow 300 of the device 101 and an exemplary screen shot of an exploration view 380 are shown in accordance with the exemplary embodiments. In this example, the exploration view 380 can include connectivity indicators 410, 420, a media file area 405, weighting sliders 360 and navigational controls 372, 373. The connectivity indicators 410 and 420 can indicate to a user when one or more peripheral devices 190 are connected to the device 101 and/or when the device 101 is connected to a one or more networks 191. It is noted that the peripheral devices 191 can include, but are not limited to, computers, multimedia devices, mobile communication devices and memory devices. The network indicator can indicate a location on a network (e.g. web page, directory path, etc.) that the device 101 is accessing. The explorer view 380 provides the user with a display of the media items where the media items are grouped, for example, based on the distance (i.e. how closely related the different media items are) of the connections and links between the different media items 310. The distance of the media items can be based on one or more of the media item features described above so that media items with parameters in common are closer together than media files that do not have any or few parameters in common. The media item features provide common measures (e.g. the media item features are the same) for grouping the media items. If the media item features are not the same the features can be compared in any suitable manner so that different media types can be associated with each other for display in the exploration view 380. As a non-limiting example, when a music file and an image file do not have common metadata the tempo of a music file can be compared to the brightness of an image when associating different media files.

In this example, the media items or files can be gathered from the peripheral device 190, the network 191 and/or the storage 180 of FIG. 1. The media item feature data 320 are extracted from the media files 310 in any suitable manner. The device 101 can be configured so that the media item feature data 320 is passed to a self organizing map engine 350 and transformed into a multidimensional feature dataset 330. The self organizing map engine 350 can be part of the processor 125, classifier 182 or be a separate module. The self organizing map engine 350 is configured to apply the weighting factors 360 to the feature data 320 and create feature vectors corresponding to the feature data 320. It is noted that the device 101 can be configured to treat some of the feature vectors as a loop as some feature vectors can be circular in nature (e.g. the hue component of the hue saturation value). The self organizing map engine 350 uses the feature vectors to match and create associations between the different types of data in the multidimensional feature dataset 330 so that a spatial item data set 340 is created. The spatial item data set 340 can be a multidimensional relational representation between each of the media items 310.

In the examples described herein the multidimensional relationships between the media items have a two or three dimensional representation but in other embodiments any suitable number of dimensions can be used. The spatial item dataset 340 is mapped to a spatial coordinate system 390 of the display 114 so that the media items 310 are presented on the display 114 as groups according to the relationships established by the self organizing map engine 350. The mapping of the spatial item dataset 340 can be done in any suitable manner such as, for example, with an artificial neural network algorithm of the self organizing map engine 350 that can learn the interdependencies between the media items 310 in an unsupervised way. The self organizing map engine 350 can group or place each media item 310 into the most suitable cell of the neural network based on the feature vectors. Each cell's location in the neural network can be a crude spatial location that is later refined using a local gradient of the self organizing map engine 350 and some randomness. In one embodiment, it is noted that the presentation of the media items 310 is “fuzzy” or unclear in that the cells do not describe an exact relationship between the grouped media items 310. In other embodiments, the device can be configured to provide exact relationships between the grouped media items 310.

After the spatial location of the media items 310 on the display is determined any suitable indicators of the media content are created and placed in the spatial coordinate system and projected on the display in the explorer view 380 using any suitable rendering features of the device 101. In this example, as can be seen in FIGS. 4-6 content cards or thumbnails 450 for each of the media items are created and projected on the display 114. In one embodiment, the thumbnails 450 can provide a “snapshot” or still image of a corresponding media content. For example, where the thumbnail corresponds to a video, a frame of the video can be shown in the thumbnail. In another example, where the thumbnail 450 corresponds to a music file, an album cover or artist picture can be presented. In another embodiment, the thumbnails 450 can be configured as animated thumbnails, so that if a corresponding content of the thumbnail 450 includes sound and/or video, that sound and/or video is played when the thumbnail 450 is presented. Similarly where the corresponding file is an executable file the thumbnail(s) 450 can be configured to allow the executable to run within the respective thumbnail. In still other embodiments, as the user selects or otherwise passes a pointing device over a thumbnail 450 any corresponding sound and/or video can be played. The thumbnails 450 can also be configured so that when a thumbnail 450 is selected or when a pointing device passes over the thumbnail 450, the thumbnail 450 may be zoomed in or otherwise enlarged on the screen so the user can clearly see the media file associated with the thumbnail 450.

It is noted that the difference between media item features determines a media item's position relative to other media items on the display 114. In one embodiment, when creating the feature vectors described above and comparing media items having, for example, the different file types described above any suitable combinations of the media item features can be used. For exemplary purposes only, one combination of features that can be used to form feature vectors for comparing the different media types can include a date, usage count and recording date of music so that files of the different data types having at least these features in common (or at least having similar features) are grouped via the comparison. Another exemplary combination can include tags, keywords, file name, title, metadata and words in a text file. Still another exemplary combination of features can include lightness/darkness of an image/video, slow/fast tempo of music, genre of music and length of words in text. One example of a media file grouping created from comparison of the different combinations of media item features is that music files having similar tempos can be closely grouped together. In another example, bright images/video and text having short words can be associated and grouped with music files having a fast tempo while text having long words and dark images/video can be grouped with music having a slow tempo. The larger the difference between the media item features of one media item with respect to the media item features of another media item, the further apart the media items will be on the display. As can be seen in FIG. 4, media items 310A, 310B are closely grouped together (e.g. some or all of the media item features are similar) whereas media item 310C is located on the other side of the display by itself (e.g. media item 310C does not have similar media item features with respect to at least media items 310A, 310B).

In one embodiment, informational data can be presented along with each grouping of items. This informational data can indicate, for example, features that the items within the group share with each other. For example, information 480 shown in FIG. 4 indicates that media items 310A, 310B share a common date with each other. In other embodiments the information presented can be an average or approximation of the shared features. For example, item 310A may have a creation date of 14 Nov. 2004 while items 310B has a creation date of 14 Dec. 2004 such that the information presented next to items 310A, 310B is a date referring to approximately when the items were created. In other examples, any of the item features described herein or any other suitable information can be presented along with the item groupings and/or with ungrouped items.

The position of and relationship between each of the media items 310 in the spatial coordinate system can be dynamically changed in any suitable manner. In one embodiment the position and relationship of the media items 310 can be changed by manipulating, for example, the weighting factors applied to the feature data 320. These weighting factors can be manipulated in any suitable manner such as through the menu system 124 described above. In this example, manipulation of the weighting factors will be described with respect to weighting sliders 490-493, which may be part of the menu system 124. Here each of the weighting sliders 490-493 can be associated with any suitable number and/or types of feature data 320. In one embodiment the sliders 490-493 may hide specific weighting parameters from the user and provide a way to generally modify the weighting parameters for grouping the media items 310. For exemplary purposes only slider 490 may be associated with text related feature data, slider 491 can be associated with time and locational feature data and slider 492 can be associated with music tempo, image and/or video brightness and word length feature data and slider 493 can be associated with a size or length of the media items. In other embodiments, there may be a slider for each specific weighting parameter to allow specific searches to be performed.

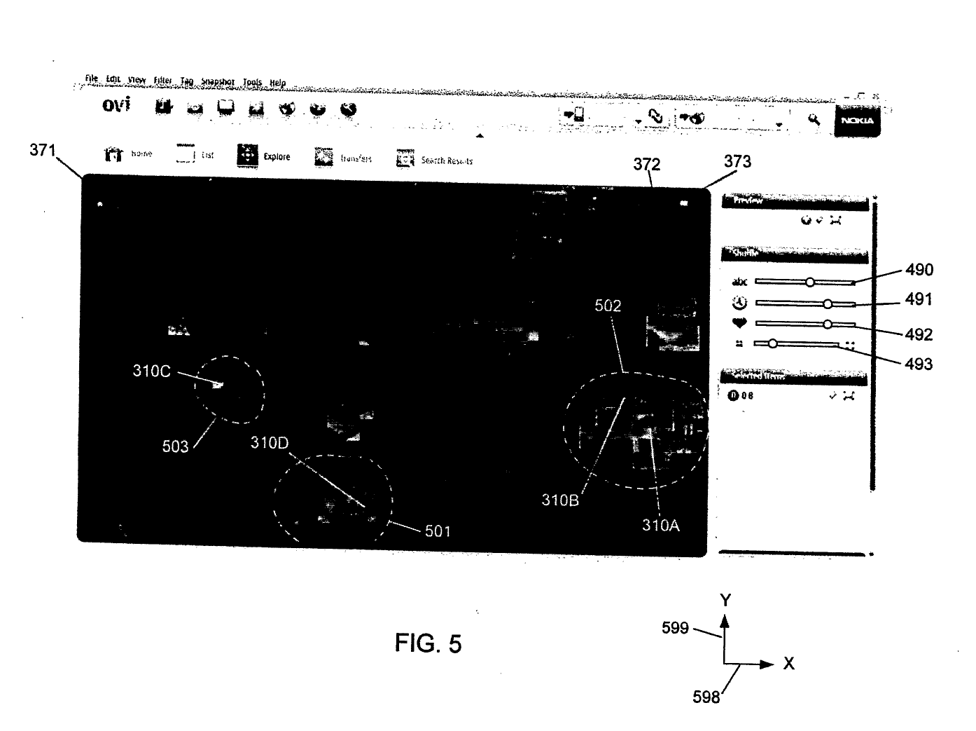

As can be seen in FIGS. 4 and 5 as the sliders 490-493 are moved to change the weighting associated with one or more media item features media items are added to, re-positioned on and/or removed from the display 114 depending on the weighting applied to the feature data 320. As can be seen in FIG. 5, the spatial visualization of the media items 310 is changed so that media items 310A, 310B are grouped in grouping 502, media item 310D is grouped in grouping 501 and media item 310C is grouped in grouping 503. In other embodiments, as noted above, the one or more media item features can be selected so that the grouping of the media files can be performed according to only those selected media item features.

In one embodiment, the device 101 can be configured so that the media items 310 can be manually moved from one group to another group in any suitable manner such as, for example, drag and drop, cut an paste, etc. For example, media item 310A can be removed from group 502 and placed in group 501. The device can be configured to track the manual placement of the media items within the different groups 501-503 and apply this information to the neural network so that the device “learns” how to arrange the media items according to, for example, a user preference or relationships known by the user but not previously defined within the device 101. These learned relationships can be applied to other media items to refine the grouping of the media items. The manual placement of the media items can also cause the device 101 to copy a corresponding metadata to the manually placed media items. For example, if one item is moved to a group having metadata related to a certain location, the metadata pertaining to the location will be copied or otherwise added to the moved item.

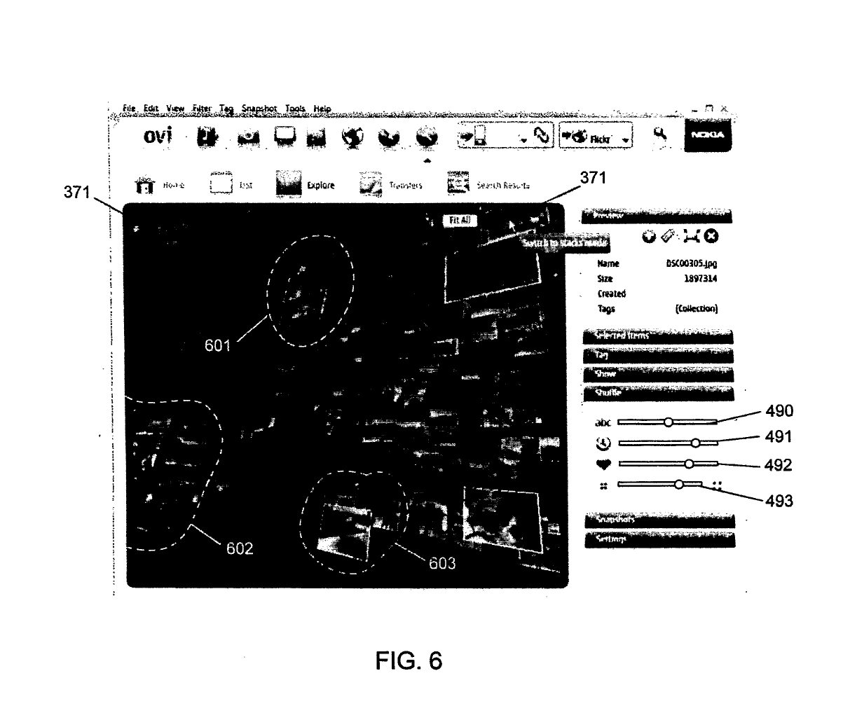

Still referring to FIGS. 4-6, the visualization of the media items 310 can be switched between any suitable number of spatial dimensions in any suitable manner. For example, in one embodiment, the media item visualization can be changed from the two dimensional visualization shown in FIGS. 4 and 5 to the three dimensional visualization shown in FIG. 6. The visualization can be switched by, for example, any suitable input of the input device 104 through, for example a navigation interface 370. The navigation interface 370 can include any suitable textual or graphical elements for navigating the explorer view 380. In this example, a spatial selector 372 is provided in the explorer view 380 for switching between two and three dimensional visualizations. As can be seen, for example, in FIG. 5 the media items 310 can be presented as two dimensional stacks 501, 502 whereas in FIG. 6 the media items 310 are presented as three dimensional clouds 601-603. In other embodiments, the device 101 can be configured to switch between the two and three dimensional presentation of the media items through manipulation of a touch screen display. For example, the media items can be rotated by any suitable amount by, for example, moving two pointing devices in a circular motion on the touch screen such that the two pointing devices are on substantially opposite sides of the circle. The media items can be rotated from the stacks 501, 502 to the clouds 601-603 depending on a desired degree of rotation (e.g. the further the pointing device travels along the circle the more the media item are rotated). The media items can be rotated about at least an X and/or Y axis 598, 599 between zero and three-hundred-sixty degrees. In other embodiments sliders can be configured to allow for the transition and progressive rotation of the media items from a two dimensional view to a three dimensional view.

Navigating through the media items 310 in the explorer view 380 can also be done in any suitable manner. In one embodiment, the device can be configured so that the media items are translated in the X-Y plane of the display 114 by dragging a pointing device across a touch screen. In other embodiments, navigational controls 371 can be provided in the explorer view for translating the media items in the X-Y plane. A zoom feature can also be provided in any suitable manner such as through, for example, navigation controls 371 to allow a user to zoom media items in or out. In another embodiment, there may be a “fit to screen” feature 373 that is configured to fit all the media items on the display 114 without having to adjust the zoom feature. In still other embodiments, the device can be configured for navigating the explorer view and/or switching between two and three dimensional views through any suitable combination of the device's 101 input features 110, 111, 112.

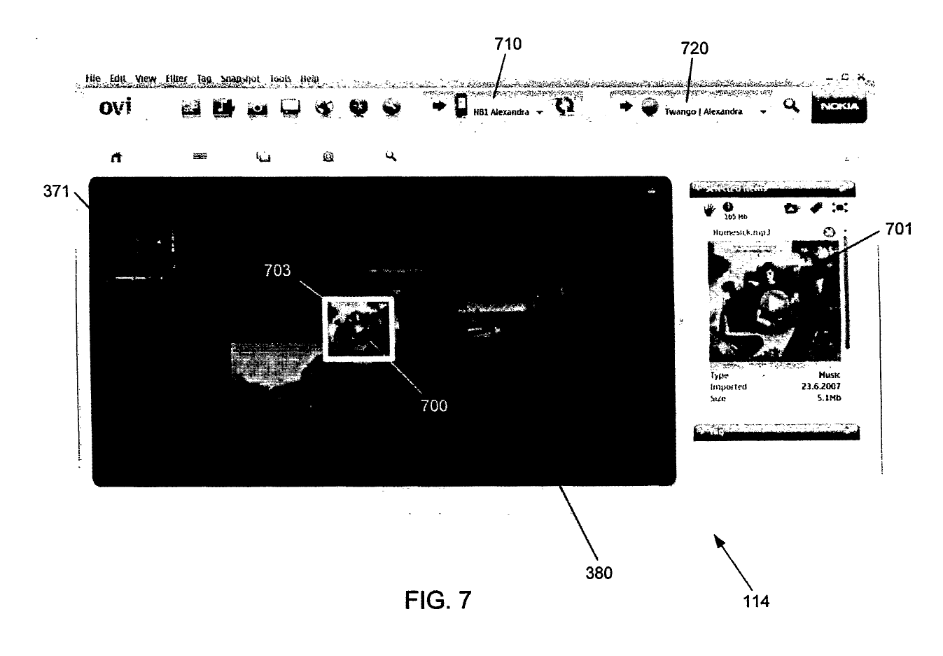

As noted above the device 101 can be coupled to peripheral devices 190 and one or more networks 191. The explorer view 380 can be configured to allow for file transfers between the device 101, peripheral devices 190 and networks 191 for any suitable reasons including, but not limited to, file sharing, backups, synchronization or otherwise managing the files. For example, referring to FIG. 7 one or more media items, such as media item 700 can be selected in any suitable manner. The appearance of the selected items can change to indicate the media item is selected. For example an outline 703 is placed around the media item 700. In other embodiments any suitable indicator can be used. In one embodiment as the media items are selected they can appear in a selected items area 701 of the explorer view display 114. The selected items can be transferred to a peripheral device in any suitable manner such as by, for example, dragging and dropping the selected media items from the explorer view 380 to the peripheral device indicator 710 and vice versa. The selected media files can be transferred to or from a network in a similar manner through the network indicator 720. It is noted that the network and peripheral device indicators 720, 710 can be configured to allow for selection between any number of different peripheral devices and/or network locations that are connected to the device 101.

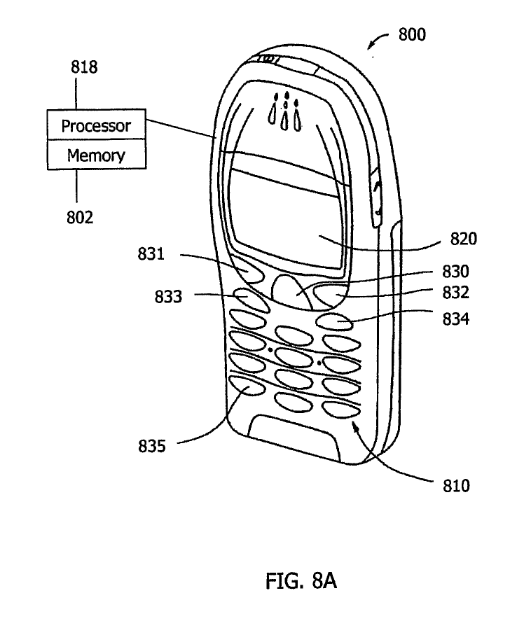

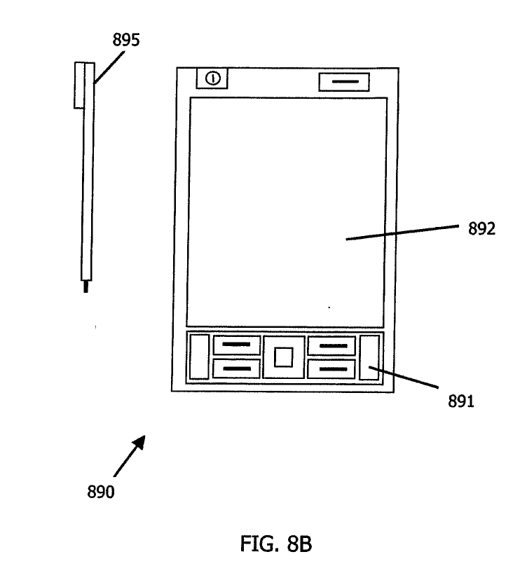

Examples of devices on which aspects of the disclosed embodiments can be practiced are illustrated with respect to FIGS. 8A and 8B. The terminal or mobile communications device 800 may have a keypad 810 and a display 820. The keypad 810 may include any suitable user input devices such as, for example, a multi-function/scroll key 830, soft keys 831, 832, a call key 833, an end call key 834 and alphanumeric keys 835. The display 820 may be any suitable display, such as for example, a touch screen display or graphical user interface. The display 820 may be integral to the device 800 or the display 820 may be a peripheral display connected to the device 800. As noted earlier, the display 820 can be a touch screen display, proximity screen device or graphical user interface. A pointing device, such as for example, a stylus, pen or simply the user's finger may be used with the display 820. In alternate embodiments any suitable pointing device may be used. In other alternate embodiments, the display 820 may be any suitable display, such as for example a flat display that is typically made of an liquid crystal display (LCD) with optional back lighting, such as a thin film transistor (TFT) matrix capable of displaying color images. In alternate embodiments any suitable pointing device may be used. In other alternate embodiments, the display may be a conventional display. The device 800 may also include other suitable features such as, for example, a camera, loud speaker, microphone, connectivity port or tactile feedback features. The mobile communications device may have a processor 818 connected to the display for processing user inputs and displaying information on the display 820. A memory 802 may be connected to the processor 818 for storing any suitable information and/or applications associated with the mobile communications device 800 such as, for example, the media items and media item classifier as described herein.

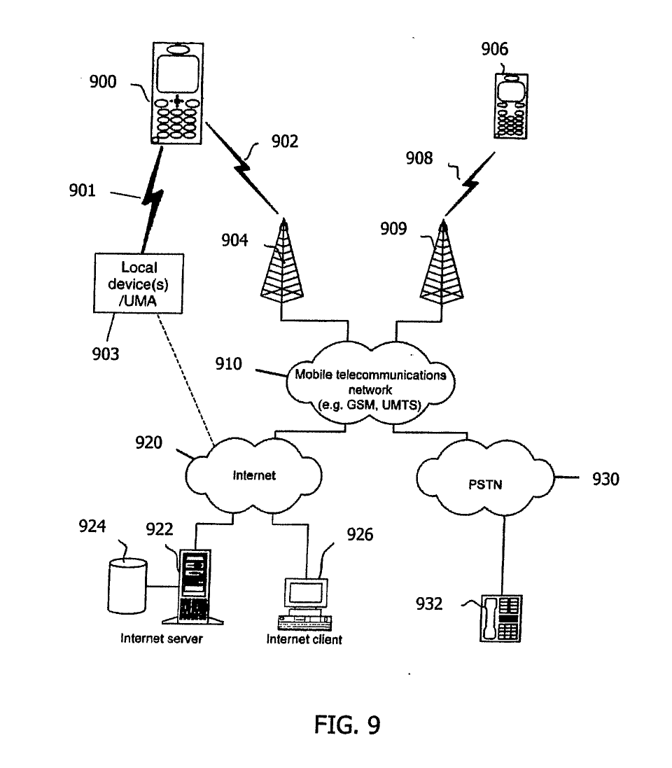

In the embodiment where the device 800 comprises a mobile communications device, the device can be adapted for communication in a telecommunication system, such as that shown in FIG. 9. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between the mobile terminal 600 and other devices, such as another mobile terminal 906, a line telephone 932, a personal computer 926 and/or an internet server 922. It is to be noted that for different embodiments of the mobile terminal 900 and in different situations, some of the telecommunications services indicated above may or may not be available. The aspects of the disclosed embodiments are not limited to any particular set of services in this respect.

The mobile terminals 900, 906 may be connected to a mobile telecommunications network 910 through radio frequency (RF) links 902, 908 via base stations 904, 909. The mobile telecommunications network 910 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 910 may be operatively connected to a wide area network 920, which may be the Internet or a part thereof. An Internet server 922 has data storage 924 and is connected to the wide area network 920, as is an Internet client computer 926. The server 922 may host a worldwide web/wireless application protocol server capable of serving worldwide web/wireless application protocol content to the mobile terminal 900.

A public switched telephone network (PSTN) 930 may be connected to the mobile telecommunications network 910 in a familiar manner. Various telephone terminals, including the stationary telephone 932, may be connected to the public switched telephone network 930.

The mobile terminal 900 is also capable of communicating locally via a local link 901 to one or more local devices 903. The local link 901 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. In one embodiment the local devices 903 may be antennas and supporting equipment forming a wireless local area network implementing Worldwide Interoperability for Microwave Access (WiMAX, IEEE 802.16), WiFi (IEEE 802.11x) or other communication protocols. In other embodiments the local devices 903 can include the device 101 as described above. The wireless local area network may be connected to the Internet. The mobile terminal 900 may thus have multi-radio capability for connecting wirelessly using mobile communications network 910, wireless local area network or both. Communication with the mobile telecommunications network 910 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the device 101 of FIG. 1 can include a communications module that is configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the device 101 of FIG. 1 may be for example, a personal digital assistant (PDA) style device 890 illustrated in FIG. 8B. The personal digital assistant 890 may have a keypad 891, a touch screen display 892 and a pointing device 895 for use on the touch screen display 892. In still other alternate embodiments, the device 101 may be a personal computer, a tablet computer, touch pad device, Internet tablet, a mobile terminal, a cellular/mobile phone, a multimedia device, a personal communicator, a set top box or any other suitable device capable of containing for example a display 114 and supported electronics such as the processor 125 and storage 180 shown in FIG. 1.

It is noted that in other embodiments the features described herein can be modified in any suitable manner to accommodate different display sizes and processing power of the device in which the disclosed embodiments are implemented. For example, in one embodiment, when the disclosed embodiments are implemented on devices with smaller displays, one or more toolbars and/or areas auxiliary to the explorer view may be omitted from the display. In another embodiment where the implementing device has limited processing power, the number of media item features used to sort and group the media items may be limited. In other embodiments, media items can be presented as frames (as opposed to thumbnails) with or without any generic content or text describing the items and/or metadata. In still other embodiments, any suitable indication of the media items can be presented on the display in any suitable manner when the capabilities of the implementing device are limited in some way.

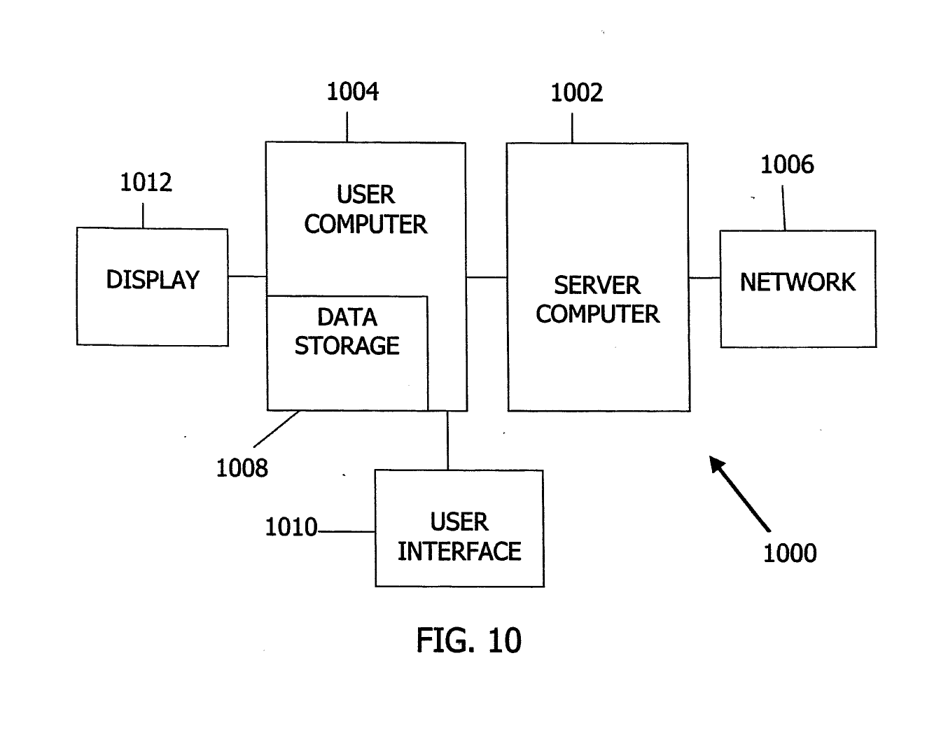

The disclosed embodiments may also include software and computer programs incorporating the process steps and instructions described above that are executed in different computers. FIG. 10 is a block diagram of one embodiment of a typical apparatus 1000 incorporating features that may be used to practice aspects of the invention. The apparatus 1000 can include computer readable program code means for carrying out and executing the process steps described herein. As shown, a computer system 1002 may be linked to another computer system 1004, such that the computers 1002 and 1004 are capable of sending information to each other and receiving information from each other. In one embodiment, computer system 1002 could include a server computer adapted to communicate with a network 1006. Computer systems 1002 and 1004 can be linked together in any conventional manner including, for example, a modem, wireless, hard wire connection, or fiber optic link. Generally, information can be made available to both computer systems 1002 and 1004 using a communication protocol typically sent over a communication channel or through a dial-up connection on an integrated services digital network (ISDN) line. Computers 1002 and 1004 are generally adapted to utilize program storage devices embodying machine-readable program source code, which is adapted to cause the computers 1002 and 1004 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1002 and 1004 may also include a microprocessor for executing stored programs. Computer 1004 may include a data storage device 1008 on its program storage device for the storage of information and data. The computer program or software incorporating the processes and method steps incorporating aspects of the invention may be stored in one or more computers 1002 and 1004 on an otherwise conventional program storage device. In one embodiment, computers 1002 and 1004 may include a user interface 1010, and a display interface 1012 from which aspects of the invention can be accessed. The user interface 1010 and the display interface 1012 can be adapted to allow the input of queries and commands to the system, as well as present the results of the commands and queries.

The embodiments described herein unify the management of different media types and provide new ways to explore media content stored in or accessed by a device. The disclosed embodiments provide for grouping different types of media items together in ways that a user of the device may not envision to provide the user with a fun and entertaining experience. The disclosed embodiments provide an easy way to browse and discovers content among, for example, a large collection of media content by building relationships between similar and/or different types of media items. The disclosed embodiments provide a way, through the relationships between media items, to re-discover media item content that may have been forgotten by a user of the device. In one aspect the disclosed embodiments also provide for a way to search for a specific media item or group of media items. The content discovery of the disclosed embodiments can function with or without metadata associated with the media files as features can be extracted from the media files themselves to build the relationships needed to group and present the media items.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances.

What is claimed is:

1-27. (canceled)

28. A method comprising:
accessing data in a device, the data comprising a plurality of types;
extracting data features from the data;
determining similarities between the data features; and
presenting the data on a display such that a multidimensional spatial relationship between the data depends on the similarities between the data features.

29. The method of claim 28 wherein determining similarities comprises defining vector spaces from one or more of the data features, such that the vector spaces allow for comparison of dissimilar data types.

30. The method of claim 28 further comprising weighting of one or more data features to influence the similarities between the data features.

31. The method of claim 30 wherein the one or more data features are hidden to provide limited user control for adjusting the weight of the one or more data features.

32. The method of claim 28 wherein the data are presented in a two dimensional 1 display space.

33. The method of claim 28 wherein indicators of the data are presented on the display.

34. The method of claim 28 wherein the data features include at least one of metadata and inferred metadata.

35. A computer program product comprising a computer-readable medium bearing computer program code embodied therein for use with a computer, the computer program code comprising: code for accessing data in a device, the data comprising a plurality of types;
code for extracting data features from the data;
code for determining similarities between the data features; and
code for presenting the data on a display such that a multidimensional spatial relationship between the data depends on the similarities between the data features.

36. The computer program product of claim 35 wherein determining similarities comprises defining vector spaces from one or more of the data features, such that the vector spaces allow for comparison of dissimilar data types.

37. The computer program product of claim 35 further comprising program code embodied in a computer readable medium for weighting of one or more data features to influence the similarities between the data features.

38. The computer program product of claim 37 wherein the one or more data features are hidden to provide limited user control for adjusting the weight of the one or more data features.

39. The computer program product of claim 35 wherein the data are presented in a three dimensional display space.

40. The computer program product of claim 35 wherein the data features include at least one of metadata and inferred metadata.

41. An apparatus comprising:
a processor;
a display; and
memory including computer program code, the memory and the computer program code configured to, working with the processor, cause the apparatus to perform at least the following:
access data associated with the apparatus, the data comprising a plurality of types;
extract data features from the data;
determine similarities between the data features; and
present the data on the display such that a multidimensional spatial relationship between the data depends on the similarities between the data features.

42. The apparatus of claim 41 wherein determining similarities comprises defining vector spaces from one or more of the data features, such that the vector spaces allow for comparison of dissimilar data types.

43. The apparatus of claim 41 wherein the processor is further configured to weighting of one or more data features to influence the similarities between the data features.

44. The apparatus of claim 43 further comprising that the one or more data features are hidden to provide limited user control for adjusting the weight of the one or more data features.

45. The apparatus of claim 41 wherein the memory and the computer program code are further configured to, working with the processor, cause the apparatus to present the data in groupings based on the similarities in a two dimensional display space.

46. The apparatus of claim 41 wherein the memory and the computer program code are further configured to, working with the processor, cause the apparatus to:
determine which data to present based on the similarities between the data features;
create indicators corresponding to data selected for presentation; and
present the indicators on the display.

47. The apparatus of claim 41 wherein the data features include at least one of metadata and inferred metadata.

48. The apparatus of claim 41 further comprising a speaker, and wherein the memory and the computer program code are further configured to, working with the processor, cause the apparatus to present an audio content of the data through the speaker.
